(19) United States
(12) Patent Application Publication
(10) Pub. No.: US 2007/0220054 A1
(43) Pub. Date: Sep. 20, 2007

(54) Audio file delivery system

(76) Inventors: Susan Kay Hunter, Portland, OR (US); John Anderton, Portland, OR (US)

Correspondence Address: SUSAN HUNTER, 1725 SE 72nd, PORTLAND, OR, 97215, US

(21) Appl. No.: 11/726,078

(22) Filed: Mar. 20, 2007

Related U.S. Application Data
(60) Provisional application No. 60/743,562, filed on Mar. 20, 2006.

(51) Int. Cl. G06F 7/00

(52) U.S. Cl. 707/104.1

(57) ABSTRACT

An audio file delivery system is disclosed that provides user recorded audio files and/or stock audio files selected by the user to a designated recipient. A user accessing a user interface may select one or more stock audio files from audio files stored in memory of an audio file server. The user may also record an audio file with a spoken greeting that is saved to server memory. The server storing the audio files may call the user to record the spoken greeting. At a specified time the server connects to a phone of a recipient and replays the files selected and recorded by the user. The audio file delivery may be associated with purchase and/or delivery of merchandise.

### RELATED APPLICATIONS

The present application claims the benefit of U.S. Provisional Patent Application Ser. No. 60/743,562, filed on Mar. 20, 2006, the complete disclosure of which is hereby incorporated by reference herein in its entirety and for all purposes.

### FIELD OF DISCLOSURE

This present disclosure relates to audio file delivery systems and to audio file delivery systems associated with purchase of merchandise.

Examples of audio file delivery systems are disclosed in U.S. Pat. Nos. 5,787,151; 6,259,772; 6,263,202 and 6,950,502. The disclosures of all of the above referenced patents are incorporated herein by reference.

### BACKGROUND

Gift selection can be challenging and time consuming for many people. Choosing an appropriate gift for a loved one or others can involve complex decisions concerning price, reciprocity, taste and preferences. Picking an inappropriate gift can be embarrassing for the giver and the receiver.

Gift cards can be very practical but may lack the personalized touch that both giver and recipient may desire. Shopping, giving and shipping online, with the giver never touching the present, can depersonalize the experience as well. Gift giving may also last for a short period. The experience may be more episodic than lasting. Once the exchange is complete, gift recipients often are tired of the clutter of more objects and feel they have to display objects that may not please them or fit the décor.

There is need of a gift for special recognition or for special occasions that is personalized, innovative, new and pleasurable for the recipient and where the recipient may receive the gift over a longer period.

### SUMMARY

An audio file recording and delivery system is disclosed. The system user may be someone wanting to give a personalized gift to a friend or relative. The user may want to give a gift that will be appreciated and is focused on the interests and preferences of the recipient, a gift that will continue to provide pleasure over a longer time span and won't add to house clutter of the recipient.

The audio file delivery system may take the form of a joke-a-day delivery system. A customer may want to send a friend a joke a day and may establish an account at a web page. At the web page the customer may select a kind of joke such as knock-knock jokes and supply a phone number for their friend. Once a day for a week, the audio file delivery system may dial up the friend's phone number and deliver a prerecorded knock-knock joke to the friend.

The user or gift giver may access the audio file delivery system in a number of ways. The user may access a web site or user interface. The user may call an operator or the user may dial an automated audio file delivery system. The user may connect through the phone or web site to a audio file server system that records transactions and schedules deliveries.

The user may supply information such as name, address and/or telephone number to establish an account or to arrange payment for service. The user may also supply recipient information. The user may identify multiple recipients.

The user may designate the genre or general type of audio file to be delivered while connected to the server system. The server system subsequently may make specific choices of audio content from that genre for each delivery. Alternately, the user may identify the specific audio content that will be delivered by identifying specific files. The user may also make a personal recording to be delivered with selected audio files.

The file system may call the user with a user supplied phone number. The user may record a message that is saved as a user recorded audio file in the server system. Alternatively, the user may record a message through a computer connected to the audio file server system or the user may call the audio file server system to record the audio file.

Once the user has recorded the required information and defined the audio file delivery to the audio file server system, they may disconnect or hang up. The audio file server system may then schedule the delivery. At each scheduled delivery time, the server system may dial the recipient. When connected, the server system may play a user recorded audio file followed by one or more selected audio files.

The audio file delivery system may be associated with a separate merchandise purchase. A florist may offer delivery of a poem as part of sending flowers. The purchaser may supply a phone number associated with the recipient and select a poem or sonnet. The purchaser may record a personal message to be replayed with the poem on delivery. The delivery of the poem may be coordinated with the physical delivery of the flowers.

The advantage of the present technology will be understood more readily after consideration of the drawings and the Detailed Description of the system.

### BRIEF DESCRIPTION OF THE DRAWINGS

FIG. 1 is a diagram of an example audio file delivery system including a user computer and user phones, recipient phones and a audio file server system connected to the internet and a phone network and including a modem server, a www server, application server and files stored in memory.

FIG. 2 is a diagram of an example audio file delivery system including a user computer and user phones, recipient phones and an audio file server system connected to the internet.

FIG. 3 is a diagram of an example audio file delivery system including a user computer and user phones, recipient phones, a audio file server system connected to the internet and a phone network and a delivery person associated with a point of sale system for selling merchandise also connected to the internet.

FIG. 4 is a diagram of an example of a web page stored on a server system with an example file system and a user computer showing how a user interface displayed on the computer may provide for selection of stock audio files stored in server system memory.

FIG. 5 is a flow chart of steps to establish an account for audio file delivery including entering data and selecting audio files.

FIG. 6 is a flow chart of steps for delivering an audio file as part of an audio file delivery system.

FIG. 7 is a flowchart of example steps for recording a user recorded audio file that may be delivered with other selected audio files.

### DETAILED DESCRIPTION

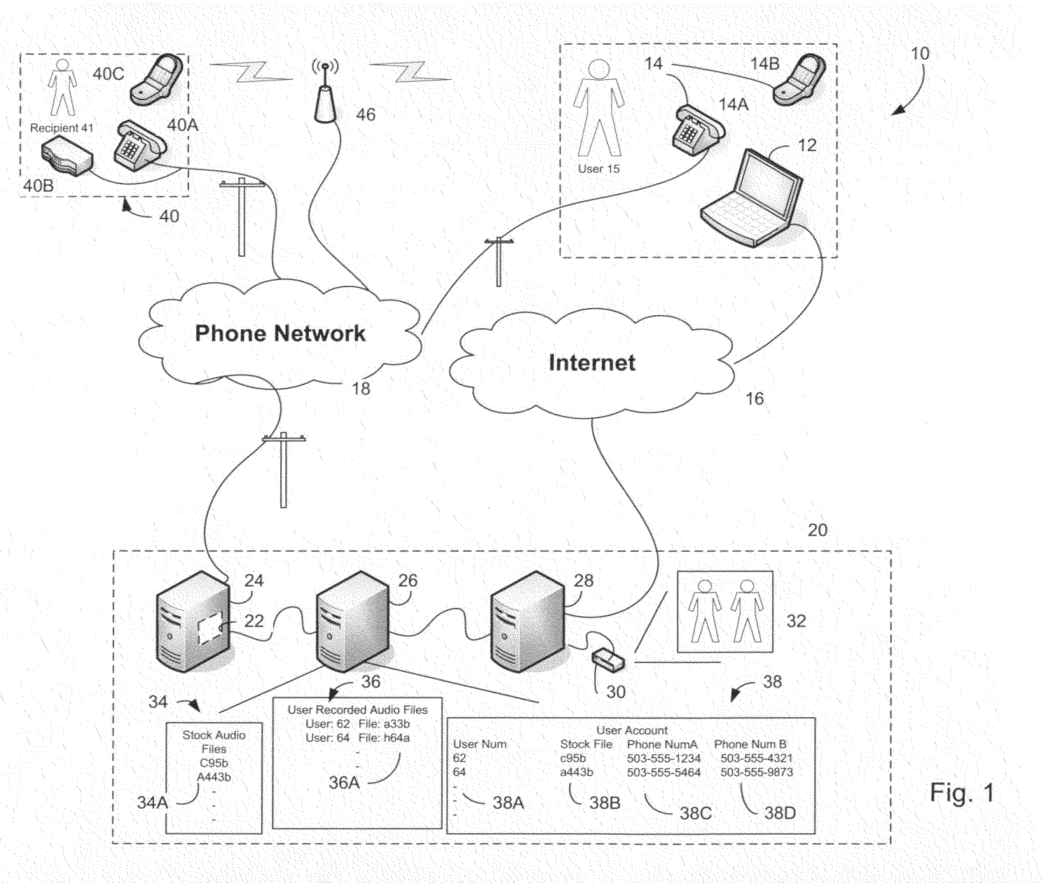

FIG. 1 is a diagrammatic view of an audio file delivery system 10. The audio file delivery system may include a user device or computer 12, user phones 14 including a telephone 14A and/or a cell phone 14B accessed by a user 15. The computer may be connected to a network or internet 16, and the user phones 14 may be connected to a phone network 18. The audio file delivery system 10 may further include a audio file server system 20 with at least one processor 22, indicated by a dotted line, a modem server 24, an application server 26 and a www server 28 also operably connected to network or internet 16. Audio file server system 20 may include memory 30 that stores at least one user interface 32, stock audio file table 34, user recorded audio file table 36 and user account table 38. Memory 30 may also store applications, algorithms, software commands, web applications, audio files, an interactive phone system and user entered data.

Stock audio file table 34, user recorded audio file table 36 and user account table 38 may be components of a relational database. Audio files 34A or 36A may be referenced or indexed by a code or filename in tables 34 and/or 36. The user account table 38 may include a user name or number field 38A, a user selected stock audio file reference 38B, a first user phone number 38C and a second recipient phone number 38D. Each order account may be a single row or a record in user account table 38.

Audio file delivery system 10 may also include recipient phones 40 including a telephone 40A, an answering machine 40B and/or a cell phone 40C, all operably connected to a phone network and/or cell network tower 46 and accessed by a recipient 41.

A user may select, record and deliver audio files using the components of audio delivery system 10. Audio file server system 20 may operate in two modes, a first mode to select and record audio files and enter data to an audio file delivery user account record, and a second mode to access the account record and deliver audio files to a specified recipient.

A user may initiate the delivery order or transaction by making a connection with computer 12 to server system 20. The user may connect to www server 28 to access user interface 32 from memory 30. User interface 32 may display icons or references for available stock audio files 34A. The user may browse different audio files at user interface 32. The user may be able to preview the audio files to hear content. The files may be arranged in genres that describe a group of files of like content. The files may also be arranged in sub-genres that are more specific and contain fewer audio files than the genres. The user may select audio files or genres for delivery at user interface 32.

The user may also enter data at user interface 32. The data entered may be saved to user account table 38. The data may include name, address, email, a user phone number 38C and/or payment information. The user may enter information for a recipient of the audio file. The user may supply name, address and email information for the recipient. The user may only enter a recipient phone number 38C. The data may be entered into user account file 38 in memory 30.

Alternatively, the user may connect to server system 20 with phone 14 over phone network 18 to enter data. The user may connect to a user interface 32 and the user may browse available audio files. User interface 32 may include an interactive voice system that responds to voice commands or an interactive voice system where the system responds to keystrokes at the user phone to enter commands. The user may browse and enter data using the interactive phone system and/or pressing keys and/or speaking commands.

The user may connect to a data entry person who enters data into user account table 38. The user may enter data into user account table 38 with keys on a phone using an interactive phone system.

The user may record an audio file to be delivered with the audio file selected from stock audio files 34. Audio file server system 20 may use data entered by the user to make a connection to telephone 14A or cell phone 14B over phone network 18. On connecting to the phone, server system 20 may prompt the user to vocalize a message that can be recorded and saved to user recorded audio file 36A. Audio file server system 20 may be interactive to allow the user to playback the recorded message, rerecord the message or perform other functions using keys or voice commands on phone 14A or 14B.

Once the user has recorded audio file 36 and other required data is entered and is saved to memory 30, the record may be complete. The user may disconnect from server system 20 by disconnecting phone 14 from phone network 18 and/or disconnecting computer 12 from internet 16.

In the second operating mode, audio file server system 20 may deliver audio files to a recipient phone 40 associated with the recipient phone number 38D. Server system 20 may to deliver the audio files to the designated recipient at an appointed time. Server system 20 may access user account table 38 at the designated time, determining the audio filenames and/or audio file locations stored in the user account records to be delivered. System 20 may select the referenced audio files from memory and combine them into a delivery package. System 20 may access recipient phone number 38D from user account table 38 and initiate a connection over phone network 18 to a recipient phone 40 such as phone 40A, machine 40B or phone 40C. On making a connection to recipient phone 40 using recipient phone number 38D, server system 20 may replay the user recorded audio file 36A and/or selected stock audio file 34A.

Server system 20 may again use an interactive system to allow the recipient to replay the audio files, end playing the audio file, cancel further audio file deliveries or other system functions.

If a recipient does not answer their phone 40, server system 20 may connect to the recipient's voice mail or answering device 40B and replay user recorded audio files 36A and/or selected audio files 34A. Server system 20 may reschedule the delivery if no connection is made or the server connects to an answering device. Having delivered the audio files, server system 20 may disconnect from the recipient phone 40 and communicate status information if required. This may end the second mode of operation of server system 20.

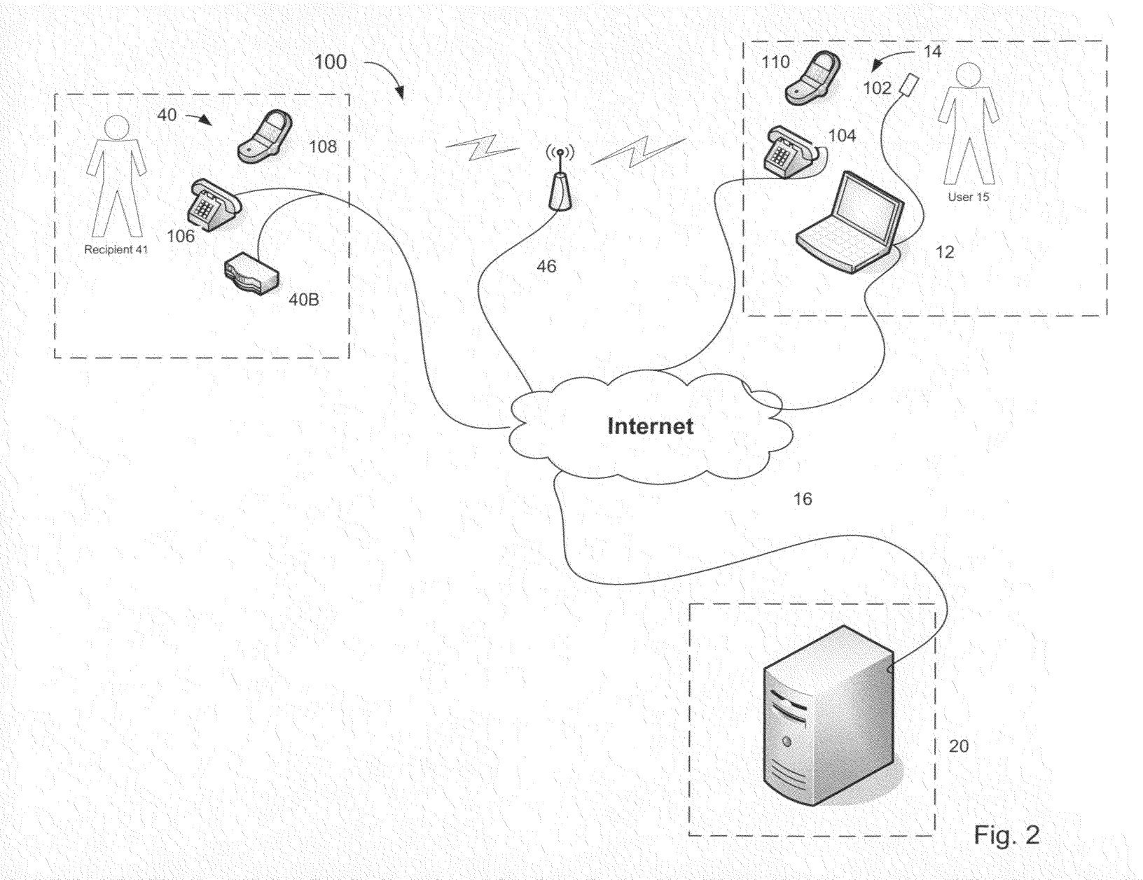

FIG. 2 shows an alternative example of a file delivery system 100 similar to file delivery system 10. System 100 includes user computer 12 connected to internet 16, headset 102 connected to computer 12, phone 14 further including voice over internet protocol (VoIP) telephone 104 and VoIP cell phone 110 connected to internet 16 and accessed by user 15. System 100 also includes audio file system 20 similar to audio file system 20 of system 10 and represented here by a single server and connected to internet 16. Server system 100 also may include recipient phone 40 further including VoIP telephone 106 and/or VoIP cell phone 108, both connected to internet 16 and accessed by recipient 41.

Audio file delivery system 100 may function in a similar manner as system 10 where the user accesses user interface 32 stored on server system 20 and makes selections and enters data that is stored on the server system. In system 100 the user may record the user recorded audio file by several alternate methods. Phones 14 may include headset or microphone 102, VoIP enabled telephone 104 or VoIP enabled cell phone 110. The user may be able to use headset 102 that includes a microphone and possibly a speaker to transfer voice input through computer 12 and a connection to internet 16 to server system 20. The user may utilize the same connection used for accessing the user interface 32 and the user interface may prompt the user for voice input.

Alternatively, the user may use VoIP enabled phones telephone 104 or cell phone 110. The user may dial a phone number to connect to server system 20 or the server system may use a phone number entered by the user to call one of the VoIP phones 104 or 110. Once connected, the user may record user recorded audio file 36A.

User phone number 38C and/or recipient phone number 38D may be an IP address associated with a VoIP system. Where a VoIP account allows VoIP users to talk to other VoIP account holders who are currently logged on, server system 20 connecting to a phone of a user or recipient may involve making a connection to the IP address of a computer 12 to establish a voice connection.

Similarly, audio file server system 20 may initiate a connection at a scheduled time with recipient VoIP phones telephone 106 or cell phone 108 over internet 16. Once connected to the recipient VoIP phone 40, server system 20 may replay user recorded audio file 36A and/or one or more user selected stock audio files 34A.

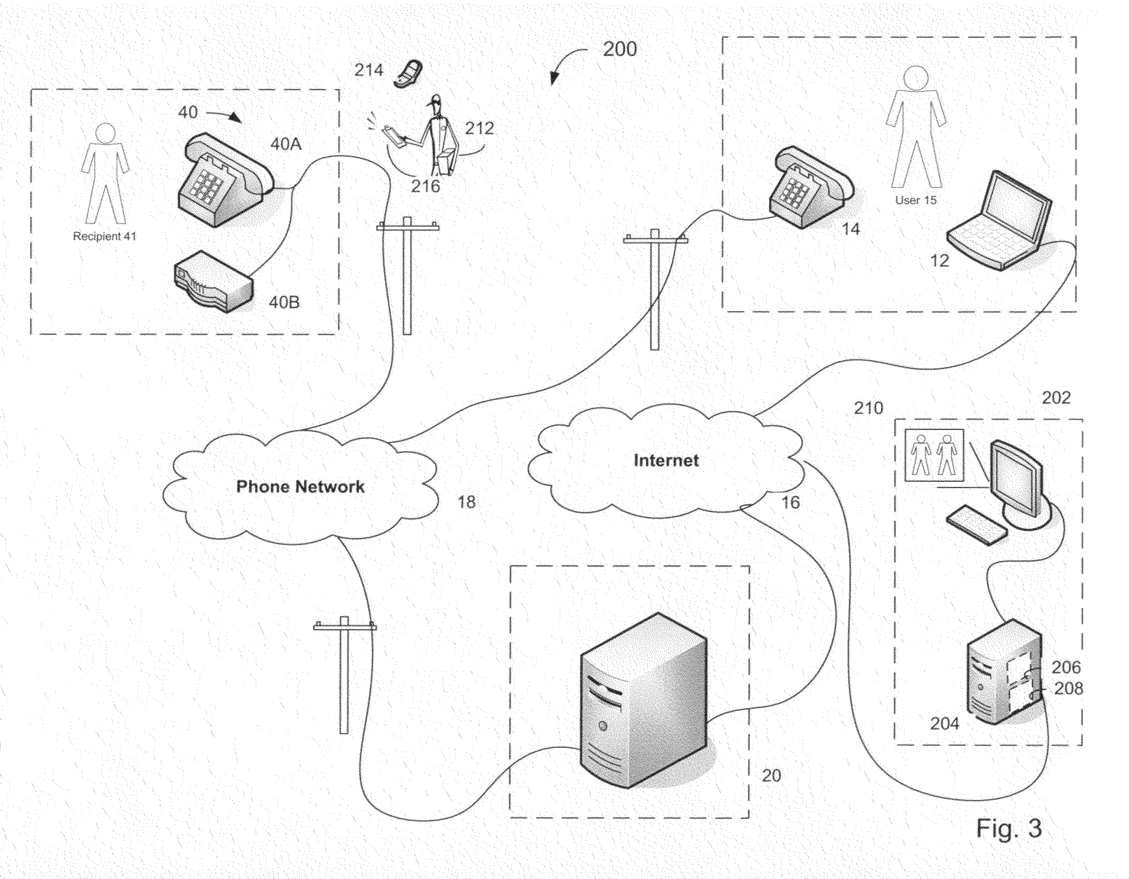

FIG. 3 is an example of an audio file delivery system 200 similar to audio file delivery system 10 of FIG. 1. System 200 may includes computer 12 connected to internet 16, user phone 14 accessed by user 15 and recipient phone 40 accessed by recipient 41 and connected to phone network 18 and audio file server system 20 connected to internet 16. System 200 further includes a point of sale system (POS) 202 that includes a POS server 204 with memory 206 and processor 208. POS server 204 may be connected to internet 16. POS 202 may be a transaction system associated with purchasing flowers, cards or other merchandise or services. A purchaser may be provided an option of including an audio file delivery with the merchandise purchase. A purchaser may be able to access a user interface such as user interface 32 on server system 20. User interface 32 may be accessed through POS server 204 at the time of purchase. The purchaser may be able to select a stock audio file 34A from user interface 32 and may be able to enter data related to audio file delivery to the recipient, such as recipient phone number 38D, that is saved in a user account table 38 on server system 20.

Alternatively, user interface 32 may be resident on POS server 204 in memory 206. User interface 32 may reference files on audio file server system 20.

Alternatively, the POS server 204 may connect to audio file server system 20. Data may be transferred between server 204 and system 20. Server system 20 may connect to the user on completing the transaction by dialing a phone number entered at POS 202. The user may select audio files and enter recipient data at user interface 32 with user phone 14. The user may record an audio file while connected to server system 20 using phone 14.

In system 200 selected audio files may be delivered to the recipient by any of the methods previously disclosed above. Server system 20 may use the user entered recipient phone number 38D to connect to a recipient phone 40.

Where the merchandise is to be delivered to the recipient, the delivery of the merchandise may be coordinated with the delivery of the audio files. A delivery person 212 may connect to server system 20 to indicate delivery of the merchandise is complete. Server system 20 in response to data from delivery person 212 may initiate delivery of user recorded audio file 36A and/or user selected stock audio file 34A.

Delivery person 212 may connect to audio file server system 20 using a phone such as a cell phone 214 and enter data through an interactive system to indicate the recipient and/or an order identifier. In response to data entered by delivery person 206, server system 20 may read data in user account table 38 to select user recorded audio file 36A and selected stock audio files 34A from memory 30 and deliver the audio files to the recipient.

Alternatively, delivery person 212 may indicate delivery of merchandise using a stock control system 216 used in association with POS 202. Stock control systems 216 are common in the art and may record financial transactions, stock levels, usage levels, delivery times and other business practices. Delivery person 212 may scan a bar code associated with the delivery of the merchandise using stock control system 210. POS server 204 may connect to server system 20 and send data and/or commands to indicate the delivery is complete. Server system 20 may respond to the data sent by POS server 204 by delivering an audio file to the recipient. Alternatively, stock control system 216 may connect directly to server system 20 to transfer delivery data.

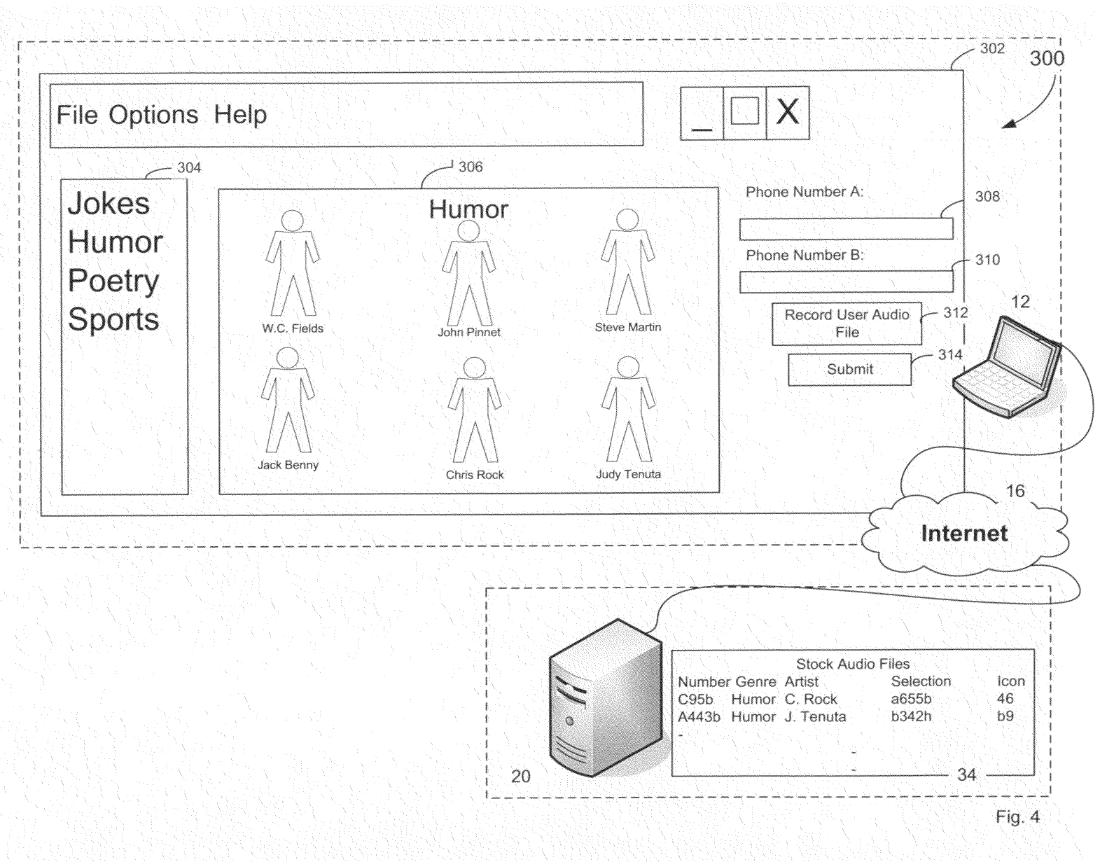

FIG. 4 is an example of a user interface in the form of a web page 302. Web page 302 may be stored on audio file server system 20 and may be displayed on user computer 12 when user computer 12 connects to audio file server system 20. Web page 302 may display more general genres at 304 as text. Icons 306 may correspond to stock audio files 34A or smaller groups or genres of audio files 34A.

The icons may correspond to a genre that corresponds to a group of stock audio files that are similar. Section 304 of web page 302 may list a grouping or genre that includes more audio files than are represented by icons 306. Selecting an icon at 306 may open another page that lists more specific audio files or groups of audio files as genres and/or icons.

Web page 302 may include fields for user data entry such as field 308 for user phone number 38C and field 310 for recipient phone number 38D. Web page 302 may include buttons 312 to initiate recording a user recorded audio file 36A and button 314 to submit entered and selected data to server system 20 to be stored in memory 30.

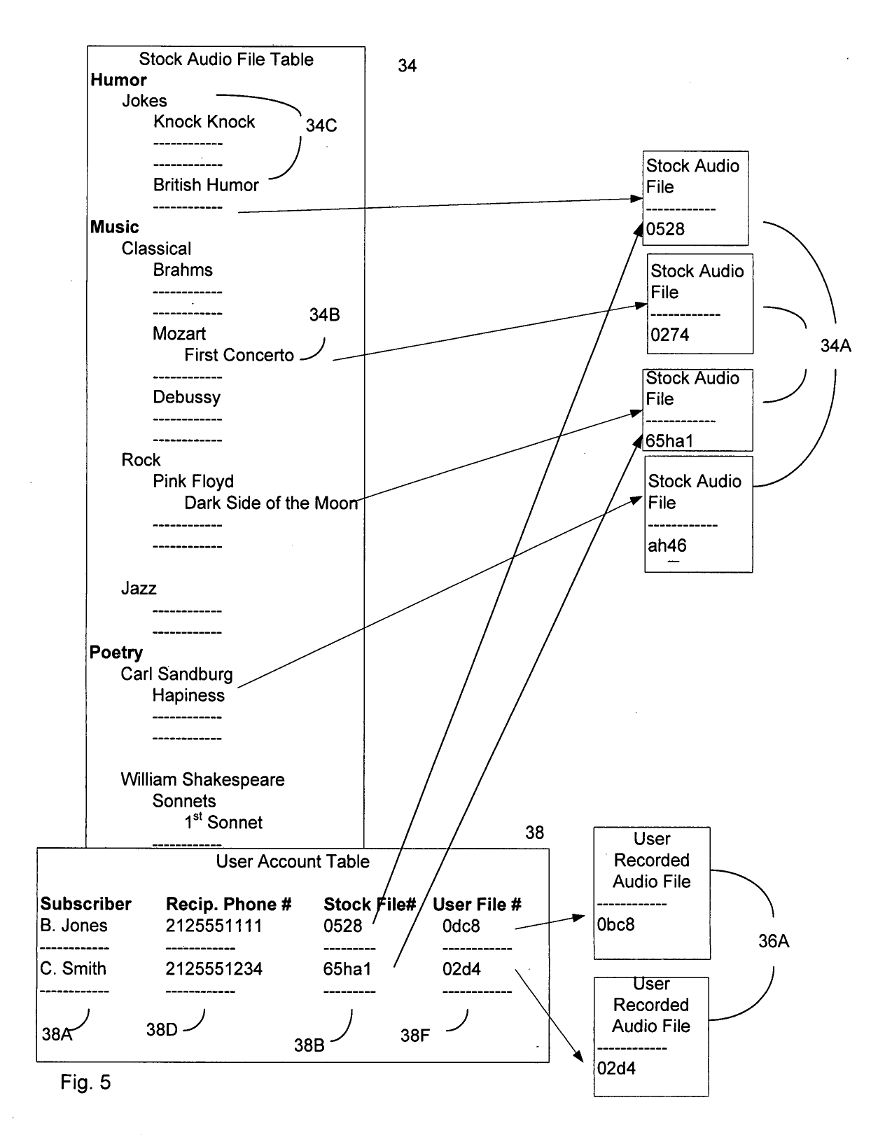

FIG. 5 shows several tables similar to tables in FIG. 1 that could be used in a database 400. Database 400 includes stock audio files table 34 that includes audio filenames or references 34B to audio files 34A stored in memory 30. Audio filenames may also be referenced by genre 34C. Database 400 may also have user account table 38 that includes subscriber 38A, recipient phone number 38D, a selected stock file 38E and a recorded user file reference 38F that references recorded audio file 36A. These are examples and the actual configuration of an audio file delivery database may be different from this and still fall within the scope of this disclosure.

In the first mode of operation system server 20 may enter data as a record into user account table 38 and create audio files 36A. In the second mode server 20 may read the record from table 38 and select audio files 36A referenced in the record.

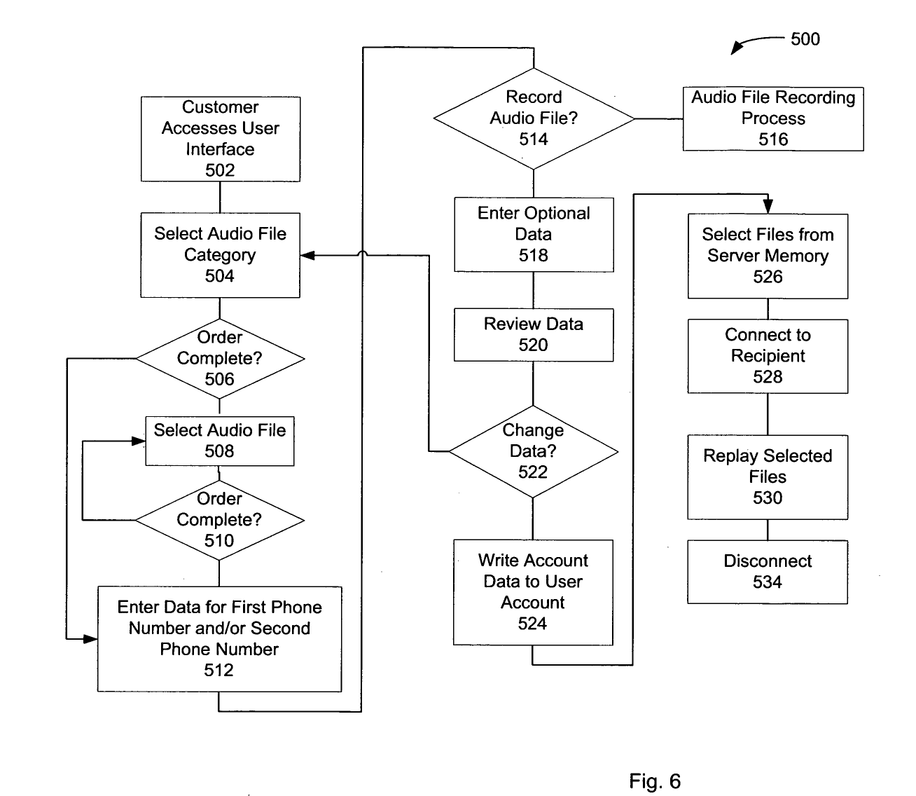

FIG. 6 is a flowchart 500 for entering data for an order and delivering the audio files. At 502 the user may access a user interface 32. At 504 the user may browse through audio file genres or groups of audio files available from memory 30 and select an audio files genre. If the order is complete at 406 the user may begin entering data at 512. Else, the user may select additional audio files 34A. The customer may select more audio files at 408 if the order is not complete at 510. Data entered at 512 may include a user phone number 38C and/or a recipient phone number 38D. If the user wants to record an audio file 36A 514 they may move to the audio file recording process 516. If not, the user may enter optional data at 518. The user may decide to edit or change entered data at 522 after reviewing data at 520.

At this point, the data entered by the user is accurate and may be written to user account table 38. At a scheduled delivery time, server 20 may select reference files from database 400 at step 526. Server system 20 may connect to recipient phone 40 using recipient phone number 38D at step 530. At step 532 the user may replay selected files. Server system 20 may disconnect at step 534 from the recipients phone 40.

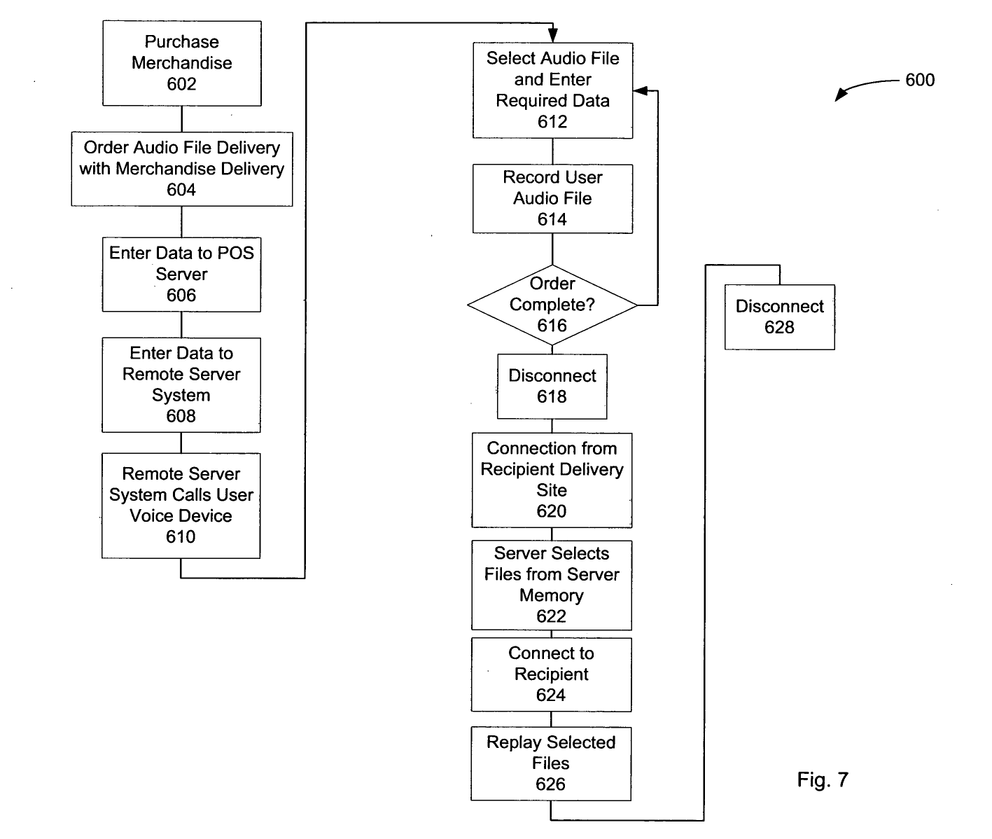

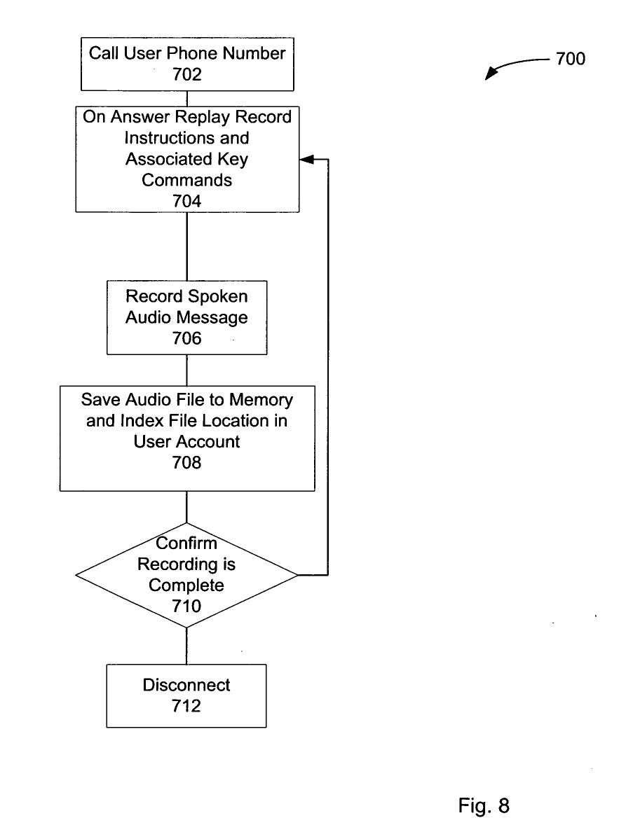

FIG. 7 is a flowchart of an audio file delivery system 600 where the audio file delivery is associated with the purchase of merchandise. At step 602 the merchandise is purchased. At 604 the user may request an audio file be delivered to a recipient. Data may be entered to a point of sale (POS) server 204. The data may include a user phone number 38C. Server 204 may be connected to network 16 and server system 20. At step 608 data may be copied to audio file server system 20. Server system 20 may connect to user phone 14 at 610. The user may interact with user interface 32 and select a genre and/or an audio file and enter additional data at 612. The user may record an audio file at 614 to be delivered with the audio file selected at step 612. if the order is complete at step 616, the user may disconnect from server system 20 at step 618. If not complete at 616 the flow may return to step 612. At 620 a delivery person 212 may connect to the server 20 on making the delivery of merchandise and enter data. Entering data may include entering a code or entering a phone number. In response to data input by delivery person 212 at 624, server system 20 may connect to the recipient using recipient phone number 38D. At 626 server system 20 may replay audio files selected and recorded by the user. At 628 the server may disconnect from the recipients phone 40.

FIG. 8 is an example flowchart 700 of possible steps for recording audio file 36A. At step 702 audio file server system 20 may connect to the user with user phone number 38C. On connecting the to user at 704, server system 20 may provide instructions for recording an audio file and accessing other functions such as replaying the recorded file and rerecording the audio file. At 706 the user may record audio file 36A. At 708 server system 20 may save the audio file to memory and index audio file 36A location or filename in user account table 38. The user may confirm that the recording is complete at 710 and disconnect from the system server 20 at 712. If recording is not complete, flow may return to step 704.

The previous flowcharts are examples of implementations of audio file delivery system functions. An actual implementation may have more, fewer or different steps. Any combination or order of steps that perform the basic functions illustrated here will fall within the scope of this disclosure.

Stock audio files may be broadly categorized as to type or genre such as music, poetry, jokes, sports or passages from short stories, novels and biographies. The files may be additionally classified into more narrow categories such as political satire, southern humor, family jokes, old time radio jokes, British humor etc. Specific audio files may be selected for delivery such as Jack Benny, Aug. 12, 1938 radio show, or Carl Sandberg's poem “Happiness” by making a selection at user interface 32. The files may be indexed further by the reader or presenter. For example, a Shakespeare sonnet may be available read by a choice of celebrity such as either Whoopi Goldberg or Morgan Freeman. Each file reference in stock audio files 34 may correspond to a file 34A. The user may make a selection from the available audio files. The user may identify a period of time and a frequency for the selections to be delivered. For example, the user may choose to have audio files delivered once a day for a week.

The user may be able to access the account at a later time and change entered information. The user may be able to cancel delivery of the audio files. The user may be able to change the audio files delivered or other parameters. The user may be able to track the status of audio file delivery such as which files have been delivered successfully. Server system 20 may inform the user if the audio files are not delivered as expected. Server system 20 may inform the user if the audio files are delivered as expected.

The user recorded audio file may be anything the user wants to include. An example might be “Happy Father's Day, Dad. I hope you enjoy this!” Users may choose not to record a personal audio file.

The audio file delivery server system may concatenate user recorded audio files, selected stock files and other ancillary audio files into a single delivered audio file. Audio files may be customized to include additional audio content such as the user's name. For example, where the user has chosen Morgan Freeman reading Shakespeare's sonnets to be delivered, the audio file may be introduced by Morgan Freeman's voice saying “Your grandson Mark has selected Shakespeare's third sonnet for you today.” The voice synthesis system may take multiple samples of Morgan Freeman's voice and assemble the sentence. For example the sentence may be assembled from the samples “your”, “grandson”, “Mark”, “has selected”, “Shakespeare's”, “third sonnet” and “for you today.” There may be a library of proper names, words, audio file names and phrases that may be accessed and assembled or concatenated into sentences.

Audio file delivery system 10 may allow the user to select a pronunciation of their name from a library of names. For example, the user server system may request the user to listen to several options of pronunciations of the user's or recipient's names while the user is connected and select the correct pronunciation.

As an example of audio file delivery system 10 in use, the user may want to send jokes to their grandmother who is recovering from an illness. To start the process, the user may log on to a web site 32 with computer 12 and enter identification information and payment information. The user may then select a genre such as jokes and humor by someone he knows his grandmother enjoys such as Jack Benny. The user may then identify how often and for what period the audio file delivery should continue. The user may choose once a day for a week, a month or a year. The user may specify a time of day for delivery.

The user then may choose to record an audio file 36A that will be added to the delivered content. As described above, the user may be able to record user recorded file 36A over the internet connection using headset 102. The user may call a special number on the phone or they may have originally connected to server system 20 by phone and will now be able to record while connected. Server system 20 may connect to a user phone 14 associated with a user phone number 38C and once connected to the system 20 the user may record a message such as “Hi Grandma! I'm thinking about you every day and I hope you're feeling better.”

In another example, a woman may be dating a man and she may want to maintain a connection with the man without repeated calling. The woman may purchase flowers to be delivered to the main and decide to include an audio file delivery to maintain contact with the man. The woman may call server system 20 with phone 14 and enter the required identification and payment information. The woman may then select a poetry genre for the subscribed audio files. She may then select specific readings from Shakespeare sonnets read by Morgan Freeman. She may be able to preview stock audio files over the phone before she selects them.

The woman may choose to set the audio file delivery to coordinate with the delivery of the flowers. The woman may supply a phone number to the POS server 204. The phone number may be the woman's or user phone number 38C. POS server 204 or server system 20 may connect to the user supplied phone number to record a spoken audio file and a recipient phone number 38D.

Alternatively, the user may feel it is more appropriate to choose to have the audio file delivery system 10 use a default greeting such as “Mary Smith has sent you this poem for the day.” She may supply recipient phone number 38D to POS server 204. POS server 204 may connect to server system 20 and transfer data including recipient phone number and other parameter data to memory 30.

Server system 20 may then schedule the audio file delivery to occur on delivery of the flowers. Delivery person 212 may scan a bar code on the flowers to indicate they are being delivered. The bar code scanner may be connected to POS server 204 which records the delivery and the recipient. POS server may connect to audio file server system 20 and transfer data indicating delivery of the flowers. Server system 20 may select the selected audio file and the greeting file from memory 30 and any other audio files required. System 20 may dial the user supplied recipient's number 38D and play the audio files when connected to the recipient's phone 40.

System 20 may play back additional recorded information. System 20 may identify the person reading the audio content, the author, the presenter or the source of the audio content. Server system 20 may concatenate multiple audio files for delivery.

If a person answers or an answering machine answers, the user recorded audio file may be played and the selected audio file may be replayed over the phone system. Ancillary audio files may be played with information on unsubscribing from the service, and/or the user's identity repeated. At the next scheduled delivery time, another audio file may be selected and the process repeated.

Preferably, a recipient will not receive the same stock file more than once in a certain period. Server system 20 may reference transaction history for that recipient in a database table and record the audio content already delivered. Server system 20 may provide a warning or notice on selection of a stock audio file where the recipient has received that specific content previously.

Audio files may include files recorded by the user or originating from the user and may include video. Stock files may be files selected from server system 20. Other files may be included by system 20 in the delivered audio files such as opening files, closing files and content files. The delivered audio file may include a personalized audio file, an introduction audio file, which may identify the core audio content and/or may say the user's name, a core or stock audio file, which may include the poem, music, humor or other audio file the user has selected, and a closing audio file.

A connection for the purpose of this disclosure is the establishment of a communication channel for analog data or digital data. The communication channel may have at least two ends for originating and receiving data and signals. For example, a connection between computer 12 and server system 20 allows data communication over internet 16 or phone network 18 or a combination of both. The connection may allow the user to get data in the form of user interface 32 and server system 20 can get data entered by the user in the form of phone number entered at the web page. A connection between a phone 14 or 40 and server system 20 may allow a user to hear voice signals sent by the system 20 as replay of stock audio files. The user may send signals in the form of keystrokes to the server system. The connection may be terminated by either of the two ends of connection such as by hanging up a phone or terminating an internet connection.

Users and recipient phones 14 and 40 may be any device that is used for voice communication and can make a connection with a network. This may include a telephone connected to a public switched telephone network (PSTN), a cell phone network or a satellite network. Phones may include cell phone, microphones or headsets 102 connected to computer 12 that may send a voice signal to computer 12 and may send at least a representation of a voice signal over network 16 to server system 20. Phones may include PDAs or Voice over IP enabled systems that use internet protocols for sending packets with representations of a voice signal over a network. Voice signals may be transmitted and received as an analog signal, as a digital signal or as packets. The phrase “at least a representation of the voice signal” and/or “at least a representation of the audio signal” shall encompass any of these transmission and receiving methods for the purpose of this specification.

Computer 12 may be any processor based device that can connect to a network and communicate with server system 20 to receive a representation of available stock audio files, make a selection from the available audio files and enter data such as a recipient phone number. Computer 12 may be a internet enabled phone with a display. Computer 12 may be a telephone without a display.

Answering machine 40B may be a voicemail service supplied by a public switched telephone network carrier subscribed to by the recipient. The answering machine functionality may be embodied as a server system and algorithms associated with the recipient phone number but not located at the with other phones 40A and 40C.

File 34A may be an audio/video or multimedia file such as an MPEG format file. Audio file delivery system 10 may be configured to access and deliver audio/video files in the same way as audio files described above to be replayed to the recipient. For example, the user may record both audio and video of themselves telling a joke on server system 20. The user may select a stock audio/video file 34A. The user may upload an audio/video file from another source. The user may record other audio visual material for delivery by audio file delivery system 10. The user may have the audio/video recording delivered to the recipient on a cell phone 40C or 108 with video capability.

Server system 20 may be configured to allow the recipient to access stock audio files. The recipient may be able to access descriptions of audio files to be sent and they may be able to alter their list of selected files or to cancel the audio file delivery. The recipient may be able to call server system 20 and the system may identify the caller by a caller id and automatically allow them to access the account. The user may be able to log in using other information. The recipient may have limited access to the account as compared to the user.

The recipient may be able to block any further audio file deliveries being registered by anyone identifying them as recipient. The recipient may be able to block future audio file deliveries with themselves identified as recipient from a specific user

Selecting audio files for delivery may use a randomization method. Selecting audio files may involve sequencing files for selection from the file structure without randomizing. Specific audio files and dates of delivery for the specific audio files may be specified by the user.

Audio file delivery system 10 may incorporate promotion and advertising of materials associated with audio files. The system operator may associate themselves with persons or organizations wanting to promote products. Such persons may include comedians, actors, or TV personalities. For example, a publisher may want to have people hear excerpts from a new book they are publishing. The publisher may arrange for the author to record passages from the new book into an audio file or files. The audio files recorded may be made available to users at a reduced rate or for free. The audio files recorded may be sent to a user for free in conjunction with a book purchase.

Audio file delivery system 10 and audio file delivery server system 20 as shown are examples and should not be construed as limitations. Audio file delivery server system 20 may be configured as a function of the application load and size. Server system 20 may comprise a single personal computer. Server system functions may be moved from one component to another to balance loads. The server system configuration may change as the number of audio file deliverys increases or decreases and as the number of web page accesses increases or decreases.

The configuration of tables 34, 36 and 38 are examples. The data fields in tables, data in fields, naming conventions and data formats may vary from that shown and fall within the scope of this specification. Data may be referenced using methods and tools other than a database such as spreadsheets and text files.

While embodiments of an audio file delivery system and methods of use have been particularly shown and described, many variations may be made therein. This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. An appreciation of the availability or significance of claims not presently claimed may not be presently realized. Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

We claim:

1. An audio file delivery system for recording, selecting and delivering audio files comprising:
a point of sale server connected a network and including memory and configured to:
record in memory a user merchandise purchase;
record in memory user specified data including a first phone number;
an audio file server connected to the network and including:
memory for storing software commands, stock audio files, user recorded audio files, ancillary audio files and user specified data; and
a processor for executing software commands;
the audio file server configured to:
connect to the point of sale server over the network;
receive the user specified data from the point of sale server;
record in server memory user specified data received from the point of sale server;
present at a user interface stock audio files available for user selection;
record in server memory a reference to the at least one user selected stock audio file and a user supplied recipient phone number;
record a user spoken audio message;
save the recorded audio message to a user recorded audio file in server memory;
select the user recorded audio file and the user selected stock audio file from server memory;
initiate a voice connection to a recipient phone using the user supplied recipient phone number; and
replay the user recorded audio file and the user specified stock audio file at the recipient phone.

2. The audio file delivery system of claim 1 wherein the user supplied first phone number recorded in point of sale server memory is a user phone number associated with a user phone.

3. The audio file delivery system of claim 2 wherein the server system is further figured to initiate a connection to the user phone with the user phone number received from the point of sale server.

4. The audio file delivery system of claim 3 wherein the user records the spoken message saved to the user recorded audio file over the phone connection initiated by the audio file server and the user supplied recipient phone number is entered over the same connection.

5. The audio file delivery system of claim 1 where the first phone number recorded at the point of sale server is the recipient phone number.

6. The audio file delivery system of claim 1 wherein the merchandise purchase transaction includes delivery of the merchandise and a delivery person sends completion of merchandise delivery data to the audio file server and in response to receiving the delivery data the server system initiates a voice connection to the recipient phone and replays the audio files.

7. The audio file delivery system of claim 1 wherein user supplied data is entered and the user selected audio file is accessed and selected at a user interface that is resident on the audio file server.

8. The audio file delivery system of claim 1 wherein user supplied data is entered and the user selected audio file is accessed and selected at a user interface that is resident on the point of sale server.

9. An audio file delivery system for recording, selecting and delivering audio files comprising:
an audio file server connected to a network and including:
memory for storing audio files, user entered data and software commands and a user interface for selecting stock audio files stored in memory and entering data including a field for entering a user phone number associated with a user phone: and
a processor for executing software commands;
a user device connected the network and configured to:
connect to the audio file server over the network;
access the user interface resident on the audio file server, and
accept data entered at the user interface by the user including one or more selected stock audio files and the user phone number;
send the entered data to the audio file server;
wherein the audio file server is configured to:
record in memory data entered at the user interface including the user phone number;
initiate a voice connection to the user phone using the user phone number;
record an audio message spoken into the user phone device;
save the spoken audio message to a user recorded audio file in server memory;
record in memory a user supplied recipient phone number associated with a recipient phone;
select the user recorded audio file and the one or more selected stock audio files from server memory;
initiate a voice connection with the recipient phone using the user supplied recipient phone number; and
replay the user recorded audio file and the one or more user selected stock audio files at the recipient phone.

10. The server system of claim 9 wherein the user supplied recipient phone number is entered at the user interface.

11. The server system of claim 9 wherein the user supplied recipient phone number is entered at the user phone while connected to the audio file server.

12. The server system of claim 9 wherein the system further comprises a point of sale server that records a user merchandise purchase and user supplied data and the point of sale server is configured to send data over the network to the audio file server.

13. The server system of claim 12 where the merchandise purchase includes delivery of the user purchased merchandise and delivery data is sent from the point of sale server at the time of delivery and in response to the delivery data sent at the time of delivery, the audio file server initiates the voice connection and replays at least a user selected stock audio file at the recipient phone.

14. A method for audio file recording and delivery comprising:
purchasing merchandise where the purchase includes delivery of the merchandise;
recording user supplied data at the time of purchase in a point of sale server connected to a network;
making a network connection from the point of sale server to an audio file server storing a plurality of stock audio files in memory;
presenting to the user at least a representation of the plurality of stock audio files stored in audio file server memory and available for selection.
selecting one or more audio files from the available server memory stored audio files;
receiving user specified data at the audio file server from the point of sale server;
recording in audio file server memory the user specified data received from the point of sale server;
recording in server memory a reference to the at least one user selected stock audio file;
recording in server memory a user supplied recipient phone number;
recording a user spoken audio message;
saving the recorded audio message to a user recorded audio file in server memory;
receiving a notice of delivery of merchandise at the audio file server;
selecting the user recorded audio file and the at least one user selected stock audio file from server memory;
initiating a voice connection to a recipient phone associated with the user supplied recipient phone number in response to receiving the notice of delivery of merchandise; and
replaying the user recorded audio file and the user specified stock audio file at the recipient phone.

15. The system of claim 14 wherein presenting the available stock audio files includes accessing a user interface at a user device connected to the network and the recipient phone number is entered in a field of the user interface and the stock audio files are selected at the user interface.

16. The system of claim 14 wherein presenting the available stock audio files includes accessing a user interface at the point of sale server and the recipient phone number is entered in a field of the user interface and the stock audio files are selected at the user interface.

17. The system of claim 15 wherein recording a user spoken audio message includes speaking into a microphone operably connected to the user device and transmitting at least a representation of the audio signal through the network connection to the audio file server.

18. The system of claim 14 further comprising recording in audio file server memory a user supplied user phone number associated with a user phone; and
initiating a connection from the server to the user phone for recording the user spoken audio message.

19. The system of claim 14 further comprising initiating a connection from a user phone to the server for recording the user spoken audio message.
